(19) United States
(12) Patent Application Publication
(10) Pub. No.: US 2017/0142331 A1
(43) Pub. Date: May 18, 2017

(54) ELECTRONIC DEVICE AND METHOD FOR CAPTURING IMAGES

(71) Applicant: Chiun Mai Communication Systems, Inc., New Taipei (TW)

(72) Inventor: YUEH-CHI WANG, New Taipei (TW)

(21) Appl. No.: 15/348,974

(22) Filed: Nov. 10, 2016

(30) Foreign Application Priority Data
Nov. 12, 2015 (TW) 104137278

(51) Int. Cl. H04N 5/232; G06T 7/00

(52) U.S. Cl. CPC H04N 5/23222; G06T 7/0022; H04N 5/23293

(57) ABSTRACT

An image capturing method includes obtaining a group of reference parameters of an electronic device and obtaining a group of current parameters of the electronic device. Parameter differences between the group of reference parameters and the group of current parameters are calculated. A user is guided to move and rotate the electronic device according to the parameter differences. The user is reminded to capture an image when the parameter differences fall within a predetermined range.

### CROSS-REFERENCE TO RELATED APPLICATIONS

This application claims priority to Taiwanese Patent Application No. 104137278 filed on Nov. 12, 2015 in the Taiwan Intellectual Property Office, the contents of which are incorporated by reference herein.

### FIELD

The subject matter herein generally relates to image capturing technology, and particularly to an electronic device and a method for capturing images.

### BACKGROUND

Photography seizes the moment of opportunity. When the time, location, and angle settings are right, a memorable image may be captured. Reproducing a picture similar to the memorable one is a challenging task, as the view-finding process for the subsequent photo may only be done by tracing through memory. For instance, the photo taker may need to continuously recall and repeatedly apply adjustments in the hope of regaining the correct angles and camera placement.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of one exemplary embodiment of an electronic device including an image capturing system.

FIG. 2 illustrates a flowchart of one exemplary embodiment of a method for capturing an image.

FIGS. 3A-3D illustrates an example of moving the electronic device of FIG. 1.

FIGS. 4A-4D illustrates an example of rotating the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

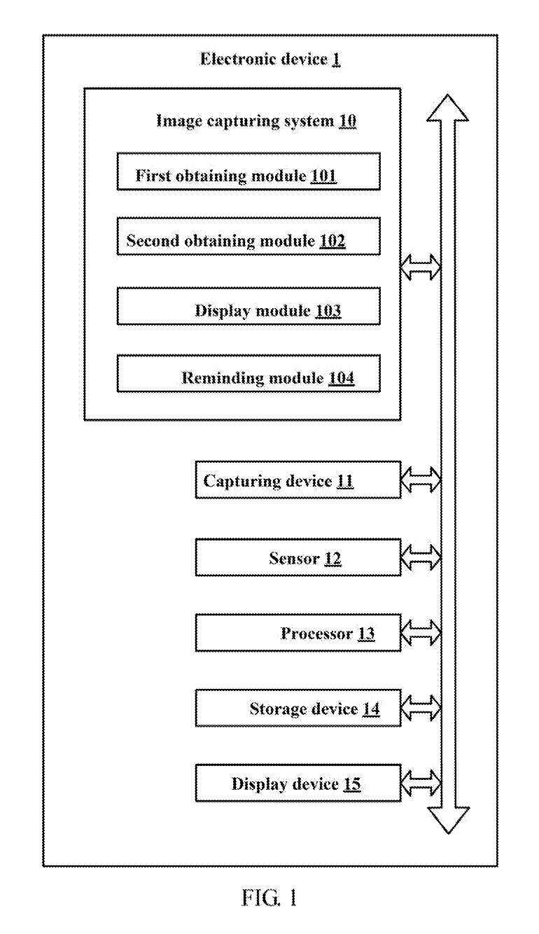

FIG. 1 is a block diagram of one exemplary embodiment of an electronic device 1 including an image capturing system 10. Depending on the embodiment, the electronic device 1 can be a portable device with a function of capturing images. For example, the electronic device 1 may be a cellular phone, a digital camera, a flat panel computer, or a tablet computer device. The electronic device 1 can include, but is not limited to, a capturing device 11, a sensor 12, at least one processor 13, a storage device 14, and a display device 15. The capturing device 11 can be a camera or a lens that is capable to capture images. The sensor 12 can detect capturing posture and movement information of the electronic device 1. The sensor 12 can be a gravity sensor, a gyroscope, or a combination of the gravity sensor and the gyroscope. In at least one exemplary embodiment, the capturing posture of the electronic device 1 can include a capturing orientation and a capturing mode of the electronic device 1. In at least one exemplary embodiment, the capturing orientation of the electronic device 1 can be defined to be an orientation of the capturing device 11 when directly facing a center of a target scene. A capturing zone of the electronic device 1 can be defined to be a predetermined zone whose center is the capturing orientation of the electronic device 1. In at least one exemplary embodiment, the capturing mode of the electronic device 1 can be defined to be a rotation angle relative to the capturing orientation of the electronic device 1. In at least one exemplary embodiment, the capturing mode of the electronic device 1 can include, but is not limited to, a landscape orientation mode, a portrait orientation mode, or a slanting orientation mode.

The at least one processor 13 can be a central processing unit (CPU), a microprocessor, or other data processor chip that performs functions of the electronic device 1.

The storage device 14 can be used to store all kinds of data of the electronic device 1. In at least one exemplary embodiment, the storage device 14 can be an internal storage device, such as a flash memory, a random access memory (RAM) for temporary storage of information, and/or a read-only memory (ROM) for permanent storage of information. The storage device 14 can also be an external storage device, such as an external hard disk, a storage card, or a data storage medium.

In at least one exemplary embodiment, the image capturing system 10 can obtain a group of reference parameters of the electronic device 1. The group of reference parameters can include a capturing position and a capturing posture of an image. It should be noted that a capturing position of one image is defined to be a capturing position of an electronic device when the electronic device captures the one image. Similarly, a capturing posture of the one image is defined to be the capturing posture of the electronic device when the electronic device captures the one image. The image capturing system 10 can further obtain a group of current parameters of the electronic device 1. The group of current parameters can include a current capturing position and a current capturing posture of electronic device 1. The image capturing system 10 can calculate parameter differences between the group of reference parameters and the group of current parameters. The image capturing system 10 can guide a user of the electronic device 1 to move and rotate the electronic device 1 according to the parameter differences. In at least one exemplary embodiment, when the parameter differences falling within a predetermined range, the image capturing system 10 can use a predetermined method to remind the user to capture an image at that moment. In other exemplary embodiments, when the parameter differences equal to zero, the image capturing system 10 can control the capturing device 11 to automatically capture an image without reminding the user.

In at least one exemplary embodiment, the image capturing system 10 can include computerized instructions in the form of one or more programs that can be stored in the storage device 14 and executed by the at least one processor 13. In at least one exemplary embodiment, the image capturing system 10 can be integrated with the at least one processor 13. In other exemplary embodiments, the image capturing system 10 can be independent from the at least one processor 13. In FIG. 1, the image capturing system 10 can include one or more modules, for example, a first obtaining module 101, a second obtaining module 102, a display module 103, and a prompt module 104.

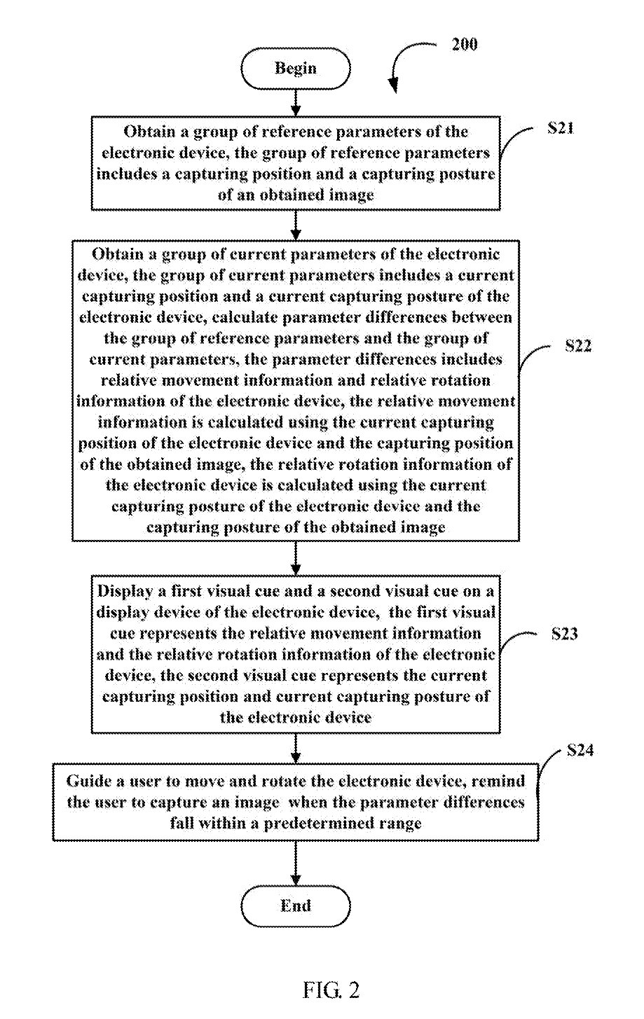

FIG. 2 illustrates a flowchart of one exemplary embodiment of a method of capturing an image. The exemplary method 200 is provided merely as an example, as there are a variety of ways to carry out the method. The method 200 described below can be carried out using the configurations illustrated in FIG. 1, for example, and various elements of these figures are referenced in explaining exemplary method 200. Each block shown in FIG. 2 represents one or more processes, methods, or subroutines, carried out in the exemplary method 200. Additionally, the illustrated order of blocks is by example only and the order of the blocks can be changed according to the present disclosure. The exemplary method 200 can begin at block S21. Depending on the embodiment, additional steps can be added, others removed, and the ordering of the steps can be changed.

At block S21, the first obtaining module 101 can obtain a group of reference parameters of the electronic device 1. In at least one exemplary embodiment, the first obtaining module 101 can obtain an image from a predetermined storage location. In at least one exemplary embodiment, the group of reference parameters includes a capturing position and a capturing posture of an obtained image. The obtained image may be an image obtained by the electronic device 1 or another electronic device. The first obtaining module 101 can obtain the capturing position and the capturing posture of the obtained image from the predetermined storage location. In at least one exemplary embodiment, the predetermined storage location can be the storage device 14, a designated website, or a designated server.

In at least one exemplary embodiment, when the predetermined storage location is the storage device 14, the storage device 14 can pre-store at least one image captured by the electronic device 1. A capturing position and a capturing posture of the at least one image are also stored in the storage device 14. The capturing position of the at least one image can be defined to be position information of the electronic device 1 when the electronic device 1 captures the at least one image. The capturing posture of the at least one image can include a capturing orientation and a capturing mode of the electronic device 1 when the electronic device 1 captures the at least one image. For example, the capturing orientation of the obtained image is in due east and the capturing mode of the obtained image is the landscape orientation mode.

In a first exemplary embodiment, the capturing position of the at least one image includes movement information of the electronic device 1 after the electronic device 1 captures the at least one image. For example, after the electronic device 1 has captured an image “A”, the electronic device 1 can record movement “AM” of the electronic device 1 using the sensor 12. For example, the movement “AM” represents that the electronic device 1 moves towards due east by 2 meters, then moves down by 0.5 meter, and then moves toward south by 1 meter. In at least one exemplary embodiment, the electronic device 1 further establishes a relationship between the movement “AM” and the image “A”. The movement “AM” can be used to determine a movement path of the electronic device 1 after the electronic device 1 captured the image “A”. For another example, after the electronic device 1 has captured an image “B”, the electronic device 1 can record movement “BM” of the electronic device 1 using the sensor 12. The electronic device 1 can further establish a relationship between the movement “BM” and the image “B”. The movement “BM” can be used to determine a movement path of the electronic device 1 after the electronic device 1 captures the image “B”. Thus, the movements “AM” and “BM” can dynamically vary with movements of the electronic device 1. In at least one exemplary embodiment, the electronic device 1 can further record the capturing posture of the electronic device 1 using a gyroscope of the electronic device 1, and establish a relationship between the capturing posture and the at least one image. In at least one exemplary embodiment, the capturing posture includes rotation information of the electronic device 1 after the electronic device 1 captured the at least one image. The capturing posture of the electronic device 1 can dynamically vary with rotations of the electronic device 1. In at least one exemplary embodiment, the capturing posture of the electronic device 1 can include rotation information of a capturing orientation and rotation information of a capturing mode of the electronic device 1.

In other exemplary embodiments, the capturing posture of the electronic device 1 can include angle information of the capturing orientation of the electronic device 1 relative to coordinate axes of a coordinate system based on Earth when the electronic device 1 captures the at least one image. The capturing posture can further include angle information of a capturing posture of the electronic device 1 relative to coordinate axes of a coordinate system based on Earth when the electronic device 1 captures the at least one image. That is, the capturing posture of the at least one image recorded using this method cannot vary with rotations of the electronic device 1 after the electronic device 1 captured the at least one image.

In a second exemplary embodiment, the capturing position of the at least one image includes relative movement information of the movement of the electronic device 1 from a first predetermined position to a second position where the electronic device 1 captures the at least one image. For example, when the electronic device 1 arrives at the first predetermined position, the electronic device 1 begins to record movement information of the electronic device 1 using the sensor 12, and records movement information of the electronic device 1 till the electronic device 1 arrives at the second position. That is, the movement information during the electronic device 1 moves from the first predetermined position to the second position can be obtained. For example, the movement information includes the electronic device 1 moves toward east by2 meters, then moves down by 0.5 meter, and then moves toward south by 1 meter. When the electronic device 1 captures the at least one image at the second position, the electronic device 1 establishes a relationship between the movement information and the at least one image. That is, the recorded movement information cannot vary with movements of the electronic device 1 after the electronic device 1 captured the at least one the image. For example, the first predetermined position is a center of a table located at a particular scenic spot, when the electronic device 1 arrives at the center of the table, the electronic device 1 begins to record movement information of the electronic device 1. That is, the recorded movement information actually is movement information relative to the center of the table. When the electronic device 1 captures the at least one image at a particular position, the electronic device 1 establishes a relationship between the recorded movement information and the at least one image captured at the particular position. In at least one exemplary embodiment, the electronic device 1 can further record a capturing posture of the electronic device 1 when the electronic device 1 captures the at least one image. The electronic device can further establish a relationship between the capturing posture of the electronic device 1 and the at least one image. In at least one exemplary embodiment, the capturing posture of the electronic device 1 can include angle information of a capturing orientation of the electronic device 1 relative to coordinate axes of a coordinate system based on Earth when the electronic device 1 captures the at least one image. The capturing posture of the electronic device 1 can further include angle information of a capturing posture of the electronic device 1 relative to coordinate axes of a coordinate system based on Earth when the electronic device 1 captures the at least one image. That is, the capturing posture of the at least one image recorded using this method, cannot vary with rotations of the electronic device 1 after the electronic device 1 captured the at least one image.

In a third exemplary embodiment, the capturing position of the at least one image can be a position of the electronic device 1 based on a predetermined positioning system when the electronic device 1 captures the at least one image. In at least one exemplary embodiment, the predetermined positioning system can accurately track a position of the electronic device 1 in three dimensions. For example, a plurality of wireless transmitters can be configured around the position where the electronic device 1 captures the at least one image. The plurality of wireless transmitters can be Bluetooth transmitters or Wi-fi transmitters. The electronic device 1 can include a positioning device. In at least one exemplary embodiment, the positioning device is capable of receiving signals from the wireless transmitters, and is capable of analyzing such received signals for determining the geographical position of the electronic device 1. In other exemplary embodiments, the positioning device can receive signals transmitted by a global positioning satellite (GPS), a global navigation satellite system (GLONASS), or a BEIDOU navigation satellite system (BDS), and can analyze such received signals for determining the position of the electronic device 1. When the electronic device 1 captures the at least one image, the positioning device can utilize the received signals to obtain a current position of the electronic device 1. The processor 13 can establish a relationship between the at least one image and the current position of the electronic device 1. In at least one exemplary embodiment, when the at least one image is captured, the electronic device 1 further records the capturing posture of the electronic device 1, and establishes a relationship between the capturing posture of the electronic device 1 and the at least one image. The capturing posture of the electronic device 1 includes angle information of the electronic device 1 relative to coordinate axes of a coordinate system based on Earth when the electronic device 1 captures the at least one image. In at least one exemplary embodiment, the capturing posture of the electronic device 1 can include angle information of a capturing orientation of the electronic device 1 relative to coordinate axes of a coordinate system based on Earth when the electronic device 1 captures the at least one image. The capturing posture of the electronic device 1 can further include angle information of a capturing posture of the electronic device 1 relative to coordinate axes of a coordinate system based on Earth when the electronic device 1 captures the at least one image. That is, the capturing posture of the at least one image recorded using this method does not vary with subsequent rotations of the electronic device 1 after the electronic device 1 captured the at least one image.

In at least one exemplary embodiment, when the predetermined storage location is the storage device 14 of the electronic device 1, the electronic device 1 further includes a predetermined button for activating a predetermined mode. When the predetermined mode is activated, the electronic device 1 reminds the user that each image captured thereafter can record movement information and rotation information of the electronic device 1. In at least one exemplary embodiment, the predetermined button can be a physical or a virtual button. In other exemplary embodiments, the predetermined mode can be activated automatically when the electronic device 1 is booted.

In other exemplary embodiments, when the predetermined storage location is at other designated location(s), such as the designated website or server, the predetermined storage location stores at least one image, and stores a capturing position and a capturing posture of the at least one image. The capturing position of the at least one image can be defined to be a position of the electronic device 1 when the electronic device 1 captures the at least one image.

The capturing posture of the at least one image can include a capturing orientation of the electronic device 1 when the electronic device 1 captures the at least one image. The capturing posture of the at least one image can further include a capturing mode of the electronic device 1 when the electronic device 1 captures the at least one image. For example, the capturing orientation of the at least one image is in due east, the capturing mode of the at least one image is the landscape orientation mode. The capturing position and the capturing posture of the at least one image can be those described in the second or third exemplary embodiment.

At block S22, the second obtaining module 102 can obtain a group of current parameters of the electronic device 1. In at least one exemplary embodiment, the group of current parameters includes a current capturing position and a current capturing posture of the electronic device 1. In at least one exemplary embodiment, the second obtaining module 102 can calculate parameter differences between the group of reference parameters and the group of current parameters. In at least one exemplary embodiment, the parameter differences include relative movement information and relative rotation information of the electronic device 1. The second obtaining module 102 can calculate relative movement information of the electronic device 1 using the current capturing position of the electronic device 1 and the capturing position of the obtained image. The second obtaining module 102 can calculate relative rotation information of the electronic device 1 using the current capturing posture of the electronic device 1 and the capturing posture of the obtained image.

In at least one exemplary embodiment, when the capturing position of the obtained image was recorded using the method described in the first exemplary embodiment, i.e., the capturing position of the obtained image includes the movement information of the electronic device 1 after the electronic device 1 captured the obtained image, the second obtaining module 102 obtains the recorded movement information, then the second obtaining module 102 can calculate the relative movement information using the recorded movement information and the current capturing position of the electronic device 1. In at least one exemplary embodiment, when the capturing posture of the obtained image includes rotation information of the electronic device 1 after the electronic device 1 captured the obtained image, the second obtaining module 102 obtains the recorded rotation information, then calculates the relative rotation information of the electronic device 1 using the recorded rotation information and the current capturing posture of the electronic device 1. In at least one exemplary embodiment, when the capturing posture of the obtained image includes the angle information relative to coordinate axes of a coordinate system based on Earth, the second obtaining module 102 first obtains angle information of a current capturing orientation of the electronic device 1 relative to coordinate axes of a coordinate system based on Earth, and obtains angle information of a current capturing posture of the electronic device 1 relative to coordinate axes of a coordinate system based on Earth. The second obtaining module 102 then calculates relative rotation information using the current capturing orientation of the electronic device 1 and the capturing orientation of the obtained image, and calculates relative rotation information using the current capturing mode of the electronic device 1 and the capturing mode of the obtained image.

In at least one exemplary embodiment, when the capturing position of the obtained image was recorded using the method described in the second exemplary embodiment, i.e., the capturing position of the obtained image includes movement information of the electronic device 1 relative to the first predetermined position of the movement from the first predetermined position to the second position where the electronic device 1 captures the obtained image. The second obtaining module 102 can first obtain relative movement information of the electronic device 1 using the current capturing position of the electronic device 1 and the predetermined position, and then the second obtaining module 102 calculates second relative movement information of the electronic device 1 using the current capturing position of the electronic device 1 and the position wherein the obtained image is captured. For example, when the electronic device 1 arrives at the predetermined position, the second obtaining module 102 begins to record movement information of the electronic device 1 using the sensor 12, that is, the relative movement information of the electronic device 1 relative to the position where the obtained image is captured is obtained. In at least one exemplary embodiment, the second obtaining module 102 first obtains angle information of the capturing posture of the electronic device 1 relative to coordinate axes of a coordinate system based on Earth. The second obtaining module 102 then calculates relative rotation information of the electronic device 1 using the current capturing orientation of the electronic device 1 and the capturing orientation of the obtained image, and calculates relative rotation information of the electronic device 1 using the current capturing mode of the electronic device 1 and the capturing mode of the obtained image.

In at least one exemplary embodiment, when the capturing position of the obtained image was recorded using the method described in the third exemplary embodiment, i.e., the capturing position of the obtained image includes the position of the electronic device 1 in the predetermine positioning system when the electronic device 1 captures the obtained image, the second obtaining module 102 first obtains a current position of the electronic device 1 in the predetermined positioning system. The second obtaining module 102 then calculates relative movement information of the electronic device 1 using the current position of the electronic device 1 and the capturing position of the obtained image. In at least one exemplary embodiment, the second obtaining module 102 further obtains a current capturing posture of the electronic device 1. The second obtaining module 102 first obtains angle information of the current capturing posture of the electronic device 1 relative to the coordinate axes of a coordinate system based on Earth. The second obtaining module 102 then calculates relative rotation information of the electronic device 1 using the current capturing orientation of the electronic device 1 and the capturing orientation of the obtained image, and calculates relative rotation information of the electronic device 1 using the current capturing mode of the electronic device 1 and the capturing mode of the obtained image.

At block S23, the display module 103 can control the display device 15 of the electronic device 1 to display a first visual cue. The first visual cue represents a relative relationship between the current capturing position and current capturing posture of the electronic device 1 and the capturing position and capturing posture of the obtained image. That is, the first visual cue represents the relative movement information and the relative rotation information of the electronic device 1. The display module 103 further can control the display device 15 to display a second visual cue. The second visual cue represents the current capturing position and current capturing posture of the electronic device 1. The display module 103 can dynamically adjust the first visual cue in accordance with movements and rotations of the electronic device 1. In some exemplary embodiments, the second visual cue has a fixed size, and is displayed at a central region of the display device 15. In some exemplary embodiments, a size of the second visual cue does not vary with the movements and rotations of the electronic device 1. In some exemplary embodiments, the first visual cue and the second visual cue have a same shape to enable ease of visual identification and ease of the user in adjusting the relative movement information and the relative rotation information of the electronic device 1.

The display module 103 can adjust a size of the first visual cue in accordance with change of the relative movement information of the electronic device 1. In at least one exemplary embodiment, when a distance between the current capturing position of the electronic device 1 and the capturing position of the obtained image becomes smaller, the display module 103 can enlarge the size of the first visual cue correspondingly. When the distance becomes larger, the display module 103 can reduce the size of the first visual cue correspondingly. In other exemplary embodiments, when the distance becomes smaller, the display module 103 can reduce the size of the first visual cue correspondingly. When the distance becomes larger, the display module 103 can enlarge the size of the first visual cue correspondingly.

The display module 103 can adjust a shape of the first visual cue and rotate the first visual cue in accordance with change of the relative rotational information of the electronic device 1. In at least one exemplary embodiment, the display module 103 can adjust the shape of the first visual cue by compressing or extending the first visual cue. In at least one exemplary embodiment, when an angle between the current capturing orientation of the electronic device 1 and the capturing orientation of the obtained image becomes larger, the display module 103 can compress the first visual cue. When the angle becomes smaller, the display module 103 can extend the first visual cue. In other exemplary embodiments, when the angle becomes larger, the display module 103 can extend the first visual cue. When the angle becomes smaller, the display module 103 can compress the first visual cue. In at least one exemplary embodiment, the display module 103 can set a direction that is perpendicular to the current capturing orientation of the electronic device 1 and further to the capturing orientation of the obtained image as a first reference direction. The display module 103 can compress or extend the first visual cue along a second direction that is substantially perpendicular to the first reference direction. The first visual cue can be rotated in accordance with change of an angle between the current capturing mode of the electronic device 1 and the capturing mode of the obtained image. Each of the first and the second visual cues may include a marking sign (e.g., in the form of a notch) to further enhance for the user the visual identification of rotation of the first visual cue.

The display module 103 can further adjust a position of the first visual cue on the display device 15 in accordance with a relationship between the current capturing orientation of the electronic device 1 and the capturing position of the obtained image. For example, when the current capturing orientation of the electronic device 1 is pointed toward the capturing position of the obtained image, the display module 103 can display the first visual cue at the central region of the display device 15. When the capturing position of the obtained image is within the capturing zone of the electronic device 1, the position of the first visual cue can be adjusted correspondingly. When the capturing position of the obtained image is outside the capturing zone of the electronic device 1, the display module 103 can display the first visual cue at an edge region of the display device 15. In other exemplary embodiments, when the capturing position of the obtained image is outside the capturing zone of the electronic device 1, the display module 103 does not display the first visual cue on the display device 15.

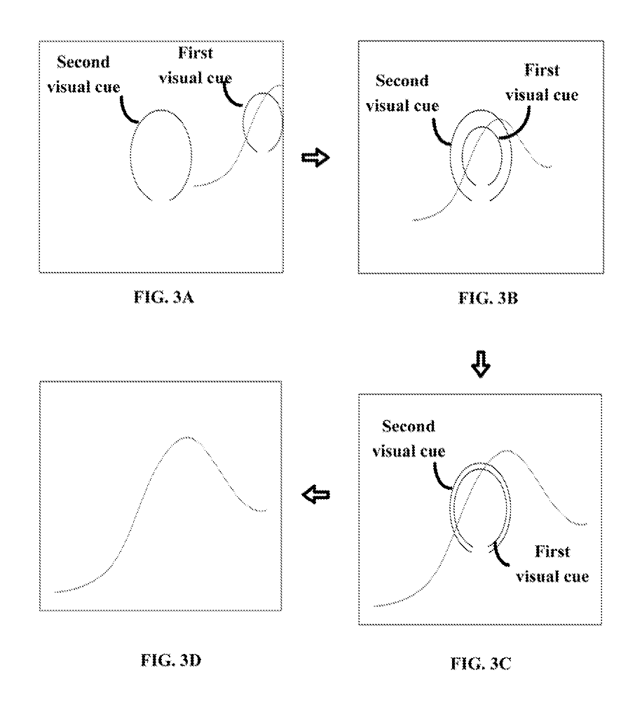

FIGS. 3A-3D illustrates an example of moving an electronic device. The current capturing posture of the electronic device 1 is same as the capturing posture of the obtained image. Under such condition, the shape of the first visual cue is not changed and the first visual cue is not rotated. The second visual cue is displayed at the center region of the display device 15. From FIG. 3A to FIG. 3B, it represents that the first visual cue can be moved to the center region of the display device 15, i.e., the capturing orientation of the electronic device 1 can be changed to be coincided with the capturing position of the obtained image by moving the electronic device 1 in an up-down direction, a left-right direction, and/or a front-back direction. From FIG. 3B to FIG. 3C, it represents the electronic device 1 moves toward the capturing position of the obtained image, the first visual cue becomes larger. FIG. 3C represents the current position of the electronic device 1 is same with the capturing position of the obtained image. Under this circumstance, a centre of the first visual cue substantially coincides with a centre of the second visual cue. FIG. 3D shows a new image captured using the capturing position and capturing posture of the obtained image. The new image is same with the obtained image.

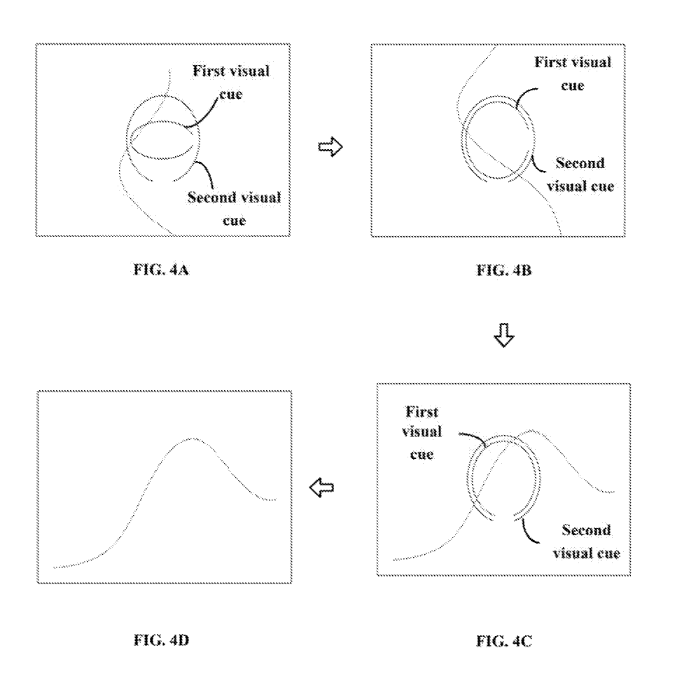

FIGS. 4A-4D illustrates an example of adjusting the capturing posture of an electronic device. FIG. 4A shows that the current position of the electronic device 1 is same with the capturing position of the obtained image, the first visual cue is displayed at the center region of the display device 15, and a size of the first visual cue is not adjusted, two end points of a long axis of the first visual cue substantially coincides with two end points of a long axis of the second visual cue. From FIG. 4A to FIG. 4B, it represents that the electronic device 1 rotates around a longer axis of the first visual cue, to enable the capturing orientation of the electronic device 1 being same with the capturing orientation of the obtained image. In at least one exemplary embodiment, the longer axis can be a horizontal axis of the first visual cue that is longer than a vertical axis of the first visual cue. From FIG. 4B to FIG. 4C, it represents that the electronic device 1 rotates around the current capturing orientation of the electronic device 1 to enable the notch of the first visual cue coincides with the notch of the second visual cue. That is, the capturing mode of the electronic device 1 is same with the capturing mode of the obtained image. FIG. 4D shows an image captured using the capturing position and capturing posture of the obtained image.

At block S24, the reminding module 104 can guide the user to move and rotate the electronic device 1 according to the parameter differences. In at least one exemplary embodiment, the reminding module 104 can guide the user via a first predetermined method. The reminding module 104 can further remind the user to capture an image via a second predetermined method when the parameter differences fall within a predetermined range. In at least one exemplary embodiment, when the parameter differences equal to zero, the reminding module 104 can automatically capture an image.

In at least one exemplary embodiment, when each of the relative movement information of the electronic device 1 and the relative rotation information of the electronic device 1 falls within the predetermined range, the reminding module 104 can automatically capture an image without reminding the user using the second predetermined method. In some other exemplary embodiments, when each of the relative movement information of the electronic device 1 and the relative rotation information of the electronic device 1 equal to zero, the reminding module 104 can automatically capture an image without reminding the user using the second predetermined method.

In at least one exemplary embodiment, the first predetermined method includes zooming in, zooming out, enlarging, reducing, and/or rotating the first and the second visual cues. In at least one exemplary embodiment, the second predetermined method includes displaying a reminder message on the display device 15 or providing audible cues. In other exemplary embodiments, the first and second predetermined methods may be used in suitable combination.

In at least one exemplary embodiment, when the relative movement information and the relative rotation information of the electronic device 1 are equal to zero, the first visual cue completely coincide with the second visual cue.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A method for capturing an image using an electronic device, the method comprising:
obtaining a group of reference parameters of the electronic device;
obtaining a group of current parameters of the electronic device;
calculating parameter differences between the group of reference parameters and the group of current parameters;
guiding a user to move and rotate the electronic device according to the parameter differences; and
reminding the user to capture an image or automatically capturing the image without reminding the user when the parameter differences fall within a predetermined range.

2. The method of claim 1, wherein the group of reference parameters comprises a capturing position and a capturing posture of an obtained image; the group of current parameters comprises a current capturing position and a current capturing posture of the electronic device, the parameter differences comprise relative movement information and relative rotation information of the electronic device, the relative movement information is calculated using the current capturing position of the electronic device and the capturing position of the obtained image, the relative rotation information of the electronic device is calculated using the current capturing posture of the electronic device and the capturing posture of the obtained image.

3. The method of claim 2, wherein the method further comprises:
when the relative movement information and the relative rotation information of the electronic device are obtained, controlling a display device of the electronic device to display a first visual cue and a second visual cue, wherein the first visual cue represents the relative movement information and the relative rotation information of the electronic device, the second visual cue represents the current capturing position and current capturing posture of the electronic device.

4. The method of claim 3, wherein the method further comprises:
adjusting a size of the first visual cue in accordance with change of the relative movement information of the electronic device.

5. The method of claim 3, wherein the method further comprises:
adjusting a shape of the first visual cue and rotating the first visual cue in accordance with change of the relative rotational information of the electronic device.

6. The method of claim 3, wherein the method further comprises:
adjusting a position of the first visual cue on the display device in accordance with a relationship between a current capturing orientation of the electronic device and the capturing position of the obtained image.

7. The method of claim 3, wherein the second visual cue has a fixed size, and is displayed at a central region of the display device.

8. The method of claim 2, wherein the capturing position of the obtained image is selected from a group comprising:
movement information of the electronic device after the electronic device captures the obtained image;
relative movement information of a movement of the electronic device from a first predetermined position to a second position where the electronic device captures the obtained image; and
a position of the electronic device based on a predetermined positioning system when the electronic device captures the obtained image.

9. The method of claim 2, wherein the capturing posture of the obtained image is selected from a group comprising:
rotation information of the electronic device after the electronic device captures the obtained image;
angle information of a capturing orientation of the electronic device relative to coordinate axes of a coordinate system based on Earth when the electronic device captures the obtained image, and
angle information of a capturing posture of the electronic device relative to the coordinate axes of the coordinate system based on Earth when the electronic device captures the obtained image.

10. An electronic device, comprising:
at least one processor; and
a storage device that stores one or more programs, when executed by the at least one processor, cause the at least one processor to;
obtain a group of reference parameters of the electronic device;
obtain a group of current parameters of the electronic device;
calculate parameter differences between the group of reference parameters and the group of current parameters;
guide a user to move and rotate the electronic device according to the parameter differences; and
remind the user to capture an image or automatically capture the image without reminding the user when the parameter differences fall within a predetermined range.

11. The electronic device of claim 10, wherein the group of reference parameters comprises a capturing position and a capturing posture of an obtained image; the group of current parameters comprises a current capturing position and a current capturing posture of the electronic device, the parameter differences comprises relative movement information and relative rotation information of the electronic device, the relative movement information is calculated using the current capturing position of the electronic device and the capturing position of the obtained image, the relative rotation information of the electronic device is calculated using the current capturing posture of the electronic device and the capturing posture of the obtained image.

12. The electronic device of claim 11, wherein the at least one processor is further caused to:
when the relative movement information and the relative rotation information of the electronic device are obtained, control a display device of the electronic device to display a first visual cue and a second visual cue, wherein the first visual cue represents the relative movement information and the relative rotation information of the electronic device, the second visual cue represents the current capturing position and current capturing posture of the electronic device.

13. The electronic device of claim 12, wherein the at least one processor is further caused to:
adjust a size of the first visual cue in accordance with change of the relative movement information of the electronic device.

14. The electronic device of claim 12, wherein the at least one processor is further caused to:
adjust a shape of the first visual cue and rotating the first visual cue in accordance with change of the relative rotational information of the electronic device.

15. The electronic device of claim 12, wherein the at least one processor is further caused to:
adjust a position of the first visual cue on the display device in accordance with a relationship between a current capturing orientation of the electronic device and the capturing position of the obtained image.

16. The electronic device of claim 12, wherein the second visual cue has a fixed size, and is displayed at a central region of the display device.

17. The electronic device of claim 11, wherein the capturing position of the obtained image is selected from a group comprising:
movement information of the electronic device after the electronic device captures the obtained image;
relative movement information of a movement of the electronic device from a first predetermined position to a second position where the electronic device captures the obtained image; and
a position of the electronic device based on a predetermined positioning system when the electronic device captures the obtained image.

18. The electronic device of claim 11, wherein the capturing posture of the obtained image is selected from a group comprising:
rotation information of the electronic device after the electronic device captures the obtained image;
angle information of a capturing orientation of the electronic device relative to coordinate axes of a coordinate system based on Earth when the electronic device captures the obtained image, and
angle information of a capturing posture of the electronic device relative to the coordinate axes of the coordinate system based on Earth when the electronic device captures the obtained image.
